(19) United States
(12) Patent Application Publication
(10) Pub. No.: US 2006/0243897 A1
(43) Pub. Date: Nov. 2, 2006

(54) Composite material lens for optical trapping

(76) Inventors: Shih-Yuan Wang, Palo Alto, CA (US); Zhiyong Li, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/116,657

(22) Filed: Apr. 27, 2005

(51) Int. Cl. H05H 3/04

(52) U.S. Cl. 250/251

(57) ABSTRACT

For manipulation of a specimen, the specimen and a focusing location of a composite material lens are brought into spatial coincidence. The composite material lens has at least one of a negative effective permittivity and a negative effective permeability at a frequency of an applied light beam. The composite material lens focuses the light beam toward the focusing location and forms an optical trap for the specimen.

### FIELD

This patent specification relates generally to the manipulation of nanoscale objects using electromagnetic radiation, and more particularly to optical trapping of nanoscale objects.

### BACKGROUND

An optical tweezer is a device that uses light to manipulate very small objects. When a laser beam is focused onto a spot surrounding a sufficiently small specimen, the specimen can be held within an optical trap formed by radiation pressure associated with refraction of the laser beam. The radiation pressure arises because light has momentum in its direction of propagation, and conservation of momentum requires that the specimen inducing the refraction must undergo an equal and opposite momentum change. Where the incoming laser beam has a spatially peaked intensity profile such as a Gaussian intensity profile, a stable optical trap can be formed, the specimen being springably maintained at a center of the optical trap.

Optical tweezers have been demonstrated as being able to trap dielectric spheres, small metal particles, viruses, bacteria, living cells, and even strands of DNA. Because of the potential for facilitating such basic abilities as moving, separating, sorting, stretching, measuring, combining, and constructing on very small scales, the optical tweezer could become a fundamentally important tool in a wide variety of endeavors ranging from bioengineering and molecular robotics to nanoelectronics and information storage technologies.

Issues that arise with known optical trapping devices include size limitations on the specimen being manipulated and/or limitations on the precision at which the manipulations can be achieved. For example, diffraction limitations impose lower limits on the size of the focal spot that can be achieved in the vicinity of the specimen, thereby limiting the smallness and/or tightness of the optical trap. In turn, there are corresponding lower limits on the size of the specimen that can be trapped and/or the spatial precision at which the manipulations can be achieved. Other issues arise as would be apparent to one skilled in the art upon reading the present disclosure.

### SUMMARY

In accordance with an embodiment, an optical tweezer for manipulating a specimen is provided. The optical tweezer comprises an optical source providing a light beam and a composite material lens exhibiting at least one of a negative effective permittivity and a negative effective permeability at a frequency of the light beam. The composite material lens focuses the light beam in a manner that optically traps the specimen.

Also provided is a method for manipulating a specimen, wherein the specimen and a focusing location of a composite material lens are brought into spatial coincidence. The composite material lens has at least one of a negative effective permittivity and a negative effective permeability at a frequency of an applied light beam. The composite material lens focuses the light beam toward the focusing location and forms an optical trap for the specimen.

Also provided is an apparatus comprising means for receiving a light beam and means for optically trapping a specimen using the light beam. The means for optically trapping the specimen comprises a composite material lens exhibiting at least one of a negative effective permittivity and a negative effective permeability at a frequency of the light beam.

### BRIEF DESCRIPTION OF THE DRAWINGS

FIG. 1 illustrates a perspective view of an apparatus for manipulating a specimen in accordance with an embodiment;

FIG. 2 illustrates a side view of an apparatus for manipulating a specimen in accordance with an embodiment; and

FIG. 3 illustrates a side view of an apparatus for manipulating a specimen and determining a degree to which the specimen is optically trapped in accordance with an embodiment.

### DETAILED DESCRIPTION

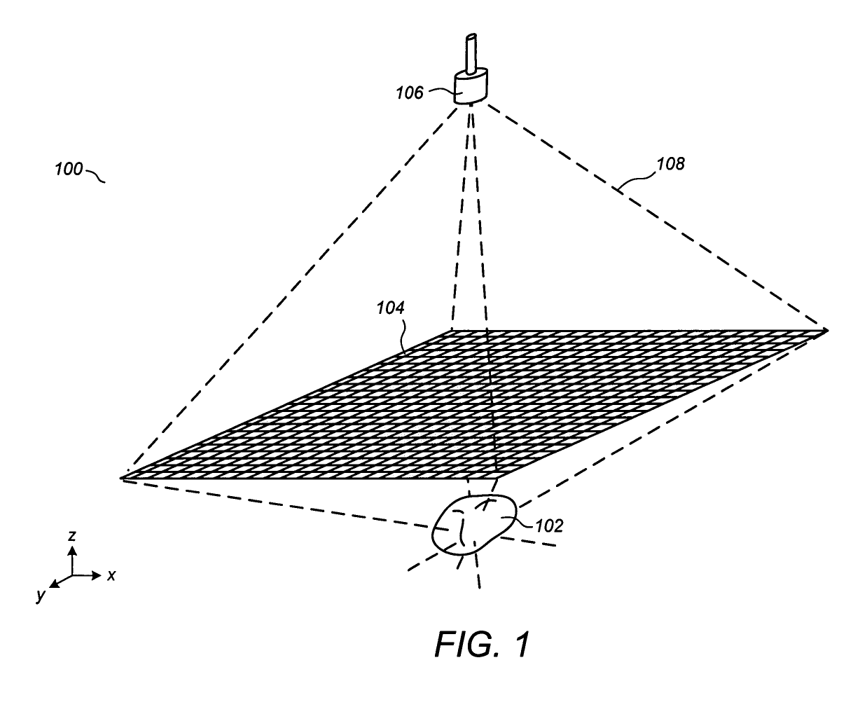

FIG. 1 illustrates an optical tweezer device 100 according to an embodiment. The optical tweezer device 100 optically traps a specimen 102. The specimen 102 can be any of a variety of objects or groupings thereof including, but not limited to, dielectric spheres, small metal particles, viruses, bacteria, living cells, inorganic molecules, organic molecules, full or partial strands of DNA, and more generally any homogenous or heterogeneous material for which manipulation is desired. Although the most common form of manipulation is usually an induced translation from one place to another, the term manipulation refers broadly herein to the assertion of any kind of force controlling, promoting, or impeding any of a translation, rotation, vibration, compression, expansion, or other kinetic attribute.

Composite materials, often interchangeably termed artificial materials or metamaterials, generally comprise periodic arrays of electrically and/or electromagnetically reactive cells that are of substantially small dimension (e.g., 20% or less) compared to the wavelength of the applied light. Although the individual response of any particular cell to an incident wavefront can be quite complicated, the aggregate response can be described macroscopically, as if the composite material were a continuous material, except that the permeability term is replaced by an effective permeability and/or the permittivity term is replaced by an effective permittivity. However, unlike continuous materials, the electrically and/or electromagnetically reactive cells have structures that can be manipulated to vary their properties, such that different ranges of effective permeability and/or effective permittivity can be achieved across various useful radiation wavelengths.

Referring again to FIG. 1, optical tweezer device 100 comprises a composite material lens 104 and an optical source 106, the optical source 106 providing a light beam 108 as represented by the dotted lines shown, the composite material lens 104 focusing the light beam 108 toward the specimen 102 in a manner that creates an optical trap for the specimen 102. By way of example and not by way of limitation, the optical source 106 may comprise an off-the-shelf laser having an output power in the range of one milliwatt to tens of milliwatts. The composite material lens 104 is configured and dimensioned to exhibit at least one of a negative effective permittivity and a negative effective permeability at a frequency of the light beam 108.

The specimen 102 is contained in a specimen plane that is generally parallel to the composite material lens 104 of FIG. 1. Preferably, the composite material lens 104 is configured and dimensioned to focus the light beam 108 to a spot on the specimen plane substantially smaller than a squared wavelength of the light beam 108, the specimen 102 being optically trapped within a volume substantially smaller than a cubed wavelength of the light beam 108. The term superlensing is sometimes used to refer to the ability of certain metamaterials, such as the composite material lens 104, to focus light upon an area smaller than what is dictated by the diffraction limitations of positive-index optics. In accordance with a smaller spot size, the optical trap holding the specimen 102 can be much smaller and tighter than the optical traps formed by positive-index lenses, and therefore the size of the specimen 102 can be made smaller and/or and the spatial precisions at which the manipulations are imposed can be made much finer.

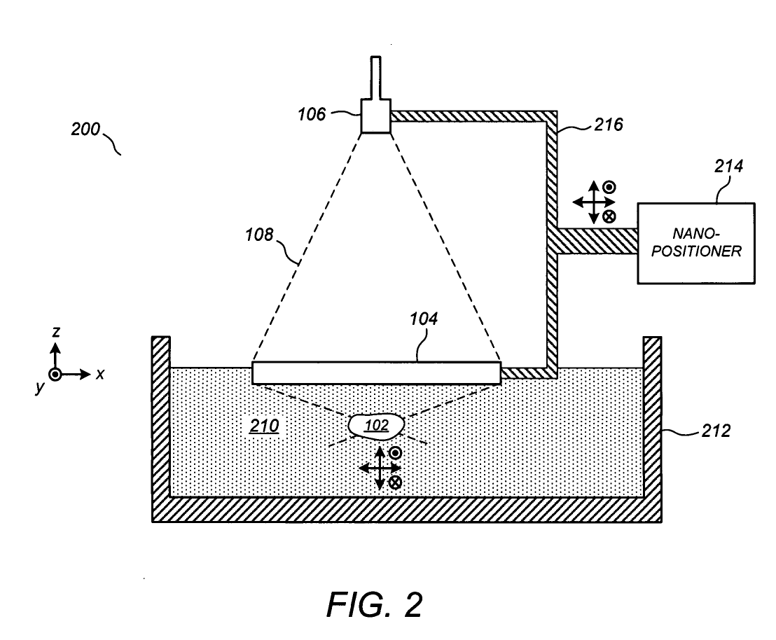

FIG. 2 illustrates a side view of an apparatus 200 for manipulating a specimen in accordance with an embodiment, including the source 106 and composite material lens 104 of FIG. 1, supra. Apparatus 200 further includes a container 212 or other suitable housing for holding a liquid 210 into which the specimen 102 is submersed and fully or partially suspended. The composite material lens 104 is also at least partially submersed, it being preferable that a constant-index environment lies between the surface of the composite material lens 104 and the specimen 102. Apparatus 200 further comprises a nanopositioner 214 that is mechanically coupled via arms 216 to cause uniform movement of the optical source 106 and the composite material lens 104 along at least three degrees of freedom including the x, y, and z directions shown in FIG. 2. The nanopositioner 214 can comprise piezoelectrically-actuated elements or other known technologies for facilitating controllable nano-motion. Once the specimen 102 is captured in an optical trap near the focusing location of the light beam 108, its position can be manipulated by the nanopositioner 214. When the specimen 102 has been moved to a desired position or is otherwise no longer of interest, it can be release by simply turning off the optical source 106.

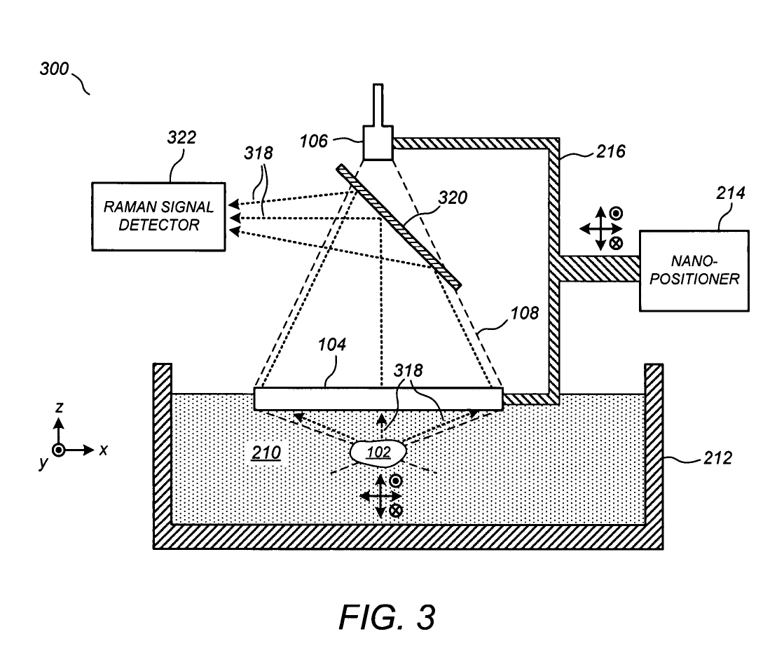

FIG. 3 illustrates a side view of an apparatus 300 for manipulating a specimen and determining a degree to which the specimen is optically trapped in accordance with an embodiment. Apparatus 300 comprises a composite material lens 104, a light source 106, a container 212 for liquid 210, a nanopositioner 214, and arms 216 as described supra with respect to FIGS. 1-2. Apparatus 300 further comprises a Raman signal detector 322 positioned and configured to detect a Raman component of backscattered light 318 from the specimen 102 through the composite material lens 102. Although many different optical configurations can be used for directing the backscattered light 318 to the Raman signal detector 322, a simple beamsplitter 320 is shown in FIG. 3 for clarity of presentation.

Raman signal detector 322 comprises known components such as collimators, lenses, gratings, and CCD detectors configured for separating the Raman component of the backscattered light 318 from other components thereof, mainly the much-stronger Rayleigh component. Whereas the Rayleigh component comprises photons that are the same wavelength as the applied photons, the Raman component is associated with inelastic interactions of the applied photons with vibrational modes in the molecule(s) of the specimen 102, leading to the emission of other photons with different frequencies than the incident photons. Since vibrational information is very specific for the chemical bonds in molecules, the Raman signal can provide a fingerprint by which molecules and/or groups of molecules can be identified. A Raman spectrum or Raman shift characteristic for a particular sample usually appears as a plot of intensity (in arbitrary units) versus a difference in wavenumber between the incident radiation at wavelength λ_{O} and the scattered radiation at λ_{R}, i.e., 1/λ_{O}−1/λ_{R}, and is usually expressed in units of cm⁻¹.

The Raman spectrum obtained from Raman signal detector 322 contains one or more peaks at wavenumber difference values that are characteristic of the specimen 102. According to an embodiment, the Raman signal detector 322 is used to at least partially determine a degree of specimen containment in the optical trap. More particularly, the Raman spectrum is measured and monitored, and if the peaks corresponding to the specimen 102 increase in magnitude, then it is determined that the specimen is more strongly trapped, whereas if those peaks decrease in magnitude, then it is determined that the specimen is more weakly trapped.

In one embodiment, the Raman signal detector 322 can also be mechanically coupled to the nanopositioner 214 to move in unison with the optical source 106 and the composite material lens 104. In one embodiment, the Raman signal detector 322 can be a one-dimensional detector, while in another embodiment, the Raman signal detector 322 can be a two-dimensional detector.

According to one embodiment, the frequency of the light beam 108 may correspond to a free-space wavelength λ between about 300 nm-1500 nm. For this frequency range, the composite material lens 104 may comprise a periodic array of criss-crossed linear conductors (like a screen on a building window) having small spacings between wires, e.g., λ/20-λ/5. A layer of silver having a thickness of about 10 nm-20 nm may be used for the conductors. In this embodiment, the specimen plane should lie in the near field, i.e., should be substantially within one wavelength λ of the composite material lens 104. This can be achieved by forming the conductive pattern on the top of a substrate that is relatively translucent at the wavelength being used, and then setting that substrate upside-down relative to FIG. 3 in direct contact with the liquid 210. In this configuration, the composite material lens 104 can exhibit a negative permittivity and can focus the light upon locations smaller than positive-optics diffraction limitations, and can be used to form a small and tight optical trap for the specimen 102. In one embodiment, for a free-space wavelength λ near 300 nm, the inter-conductor spacing may be λ/10=30 nm, and the composite material lens 104 can be a 10K×10K array with an overall dimension of 0.3 mm×0.3 mm.

A variety of different implementations for the composite material lens 104 can be used without departing from the scope of the present teachings. For longer wavelengths above 1550 nm for which negative effective permeability is desired, periodic split-ring resonator patterns having sizes and spacings on the order of 300 nm can be used, or implementations can be used similar to those described in the commonly assigned Ser. No. 10/993,616, filed Nov. 19, 2004, which is incorporated by reference herein. For wavelengths below 1550 nm for which negative permeability is desired, periodic arrays of hollow metallic cylinders may be used, the hollow metallic cylinders having diameters and inter-center spacings on the order of λ/5-λ/20 and heights on the order of λ/10−μ, or implementations can be used similar to those described in Ser. No. 11/021,615, filed Dec. 22, 2004, which is incorporated by reference herein. The composite material lens 104 is generally amenable to known photolithographic and/or nanoimprint lithography techniques. For adding negative permittivity characteristics to the negative permeability characteristics, criss-crossed linear conductor arrays can be vertically integrated on the substrate with the resonant elements (while remaining electrically separate therefrom), and/or small straight lines can emanate out from each resonant element in a manner that adds negative overall effective permittivity.

Whereas many alterations and modifications of the embodiments will no doubt become apparent to a person of ordinary skill in the art after having read the foregoing description, it is to be understood that the particular embodiments shown and described by way of illustration are in no way intended to be considered limiting. By way of example, while some embodiments supra are described in the context of negative-index materials, the features and advantages of the embodiments are readily applicable in the context of other composite materials. Examples include so-called indefinite materials (see WO 2004/020186 A2) in which the permeability and permittivity are of opposite signs.

By way of further example, it is to be appreciated that while one or more of the composite material lenses described supra are shown as having flat surfaces, in other embodiments the surfaces may be curved or have other irregular shapes in order to possess the desired superlensing properties in which diffraction limitations are superseded. By way of still further example, while one or more embodiments described supra may illustrate a focusing spot or focusing location that is in the near field relative to the composite material lens, such that the specimen plane lies in the near field, the scope of the present teachings also includes scenarios in which the specimen plane is in the far field where so permitted by the physics of the particular arrangement. Thus, reference to the details of the described embodiments are not intended to limit their scope.

1. An optical tweezer for manipulating a specimen, comprising:
an optical source providing a light beam; and
a composite material lens exhibiting at least one of a negative effective permittivity and a negative effective permeability at a frequency of the light beam, said composite material lens focusing the light beam in a manner that optically traps the specimen.

2. The optical tweezer of claim 1, said specimen being located in a specimen plane, said composite material lens focusing said light beam to a spot in said specimen plane substantially smaller than a squared wavelength of said light beam, said specimen being optically trapped within a volume substantially smaller than a cubed wavelength of said light beam.

3. The optical tweezer of claim 2, said specimen being submersed in a liquid, said composite material lens being at least partially submersed in said liquid, further comprising a nanopositioning device coupled to at least one of said optical source and said composite material lens for controlling a position of the optically trapped specimen within the liquid.

4. The optical tweezer of claim 1, said frequency of said light beam corresponding to a free-space wavelength between about 300 nm-1500 nm, said composite material lens comprising a periodic array of linear conductors having small spacing relative to said free-space wavelength and exhibiting negative effective permittivity at said frequency.

5. The optical tweezer of claim 4, the optically trapped specimen being separated from said composite material lens by a distance less than said free-space wavelength.

6. The optical tweezer of claim 1, said composite material lens comprising a periodic array of electromagnetically reactive cells of small dimension relative to a free-space wavelength of said light beam.

7. The optical tweezer of claim 1, further comprising a Raman signal detector positioned and configured to detect a Raman component of light backscattered from said specimen through said composite material lens, whereby a degree of specimen containment can be at least partially determined using said detected Raman component.

8. A method for manipulating a specimen, comprising causing a spatial coincidence between the specimen and a focusing location of a composite material lens having at least one of a negative effective permittivity and a negative effective permeability at a frequency of an applied light beam, the composite material lens focusing the light beam toward said focusing location and forming an optical trap for the specimen.

9. The method of claim 8, further comprising:
detecting a Raman component of light backscattered from said specimen through said composite material lens; and
determining a degree to which the specimen is contained within the optical trap by analyzing said detected Raman component.

10. The method of claim 9, the specimen being characterized by one or more peaks in a Raman spectrum for said frequency of said light beam, said determining comprising:
measuring and monitoring the Raman spectrum associated with said detected Raman component; and
determining that the specimen is more strongly or more weakly trapped when said peaks in said Raman spectrum exhibit increased or reduced magnitudes, respectively.

11. The method of claim 8, said specimen being located in a specimen plane, said composite material lens focusing said light beam to a spot in said specimen plane substantially smaller than a squared wavelength of said light beam, said specimen being optically trapped within a volume substantially smaller than a cubed wavelength of said light beam.

12. The method of claim 11, said specimen being submersed in a liquid, said composite material lens being at least partially submersed in said liquid, further comprising controlling a position of the specimen within said liquid using a nanopositioning device coupled to said composite material lens.

13. The method of claim 8, said frequency of said light beam corresponding to a free-space wavelength between about 300 nm-1500 nm, said composite material lens comprising a periodic array of linear conductors having small spacing relative to said free-space wavelength and exhibiting negative effective permittivity at said frequency.

14. The method of claim 13, the optically trapped specimen being separated from said composite material lens by a distance less than said free-space wavelength.

15. The method of claim 8, said composite material lens comprising a periodic array of electromagnetically reactive cells of small dimension relative to a free-space wavelength of said light beam.

16. An apparatus, comprising:
means for receiving a light beam; and
means for optically trapping a specimen using the light beam, the means for optically trapping comprising a composite material lens exhibiting at least one of a negative effective permittivity and a negative effective permeability at a frequency of the light beam.

17. The apparatus of claim 16, the specimen being located in a specimen plane, said means for optically trapping focusing the light beam to a spot in the specimen plane substantially smaller than a squared wavelength of the light beam, said specimen being optically trapped within a volume substantially smaller than a cubed wavelength of said light beam.

18. The apparatus of claim 17, further comprising:
means for suspending the specimen in a liquid;
means for at least partially submersing the composite material lens in the liquid; and
means for nanopositioning the composite material lens to control a position of the optically trapped specimen within the liquid.

19. The apparatus of claim 16, said frequency of said light beam corresponding to a free-space wavelength between about 300 nm-1500 nm, said composite material lens comprising a periodic array of linear conductors having small spacing relative to said free-space wavelength and exhibiting negative effective permittivity at said frequency.

20. The apparatus of claim 19, the optically trapped specimen being separated from said composite material lens by a distance less than a free-space wavelength of said light beam.

21. The apparatus of claim 16, said composite material lens comprising a periodic array of electromagnetically reactive cells of small dimension relative to said free-space wavelength.

22. The apparatus of claim 16, further comprising:
means for detecting a Raman component of light backscattered from said specimen through said composite material lens; and
means for determining a degree to which the specimen is optically trapped by analyzing said detected Raman component.

23. The apparatus of claim 22, the specimen being characterized by one or more peaks in a Raman spectrum for said frequency of said light beam, said means for determining a degree comprising:
means for measuring and monitoring the Raman spectrum associated with said detected Raman component; and
means for determining that the specimen is more strongly or more weakly trapped when said peaks in said Raman spectrum exhibit increased or reduced magnitudes, respectively.
